(19) United States
(12) Patent Application Publication
(10) Pub. No.: US 2013/0294290 A1
(43) Pub. Date: Nov. 7, 2013

(54) METHOD, APPARATUS, AND SYSTEM FOR ESTABLISHING PVC LINK

(71) Applicant: HUAWEI TECHNOLOGIES CO., LTD., Shenzhen (CN)

(72) Inventor: Hao ZHANG, Shenzhen (CN)

(73) Assignee: HUAWEI TECHNOLOGIES CO., LTD., Shenzhen (CN)

(21) Appl. No.: 13/938,544

(22) Filed: Jul. 10, 2013

Related U.S. Application Data
(63) Continuation of application No. PCT/CN2011/080092, filed on Sep. 23, 2011.

(30) Foreign Application Priority Data
Jan. 18, 2011 (CN) 201110020083.7

(51) Int. Cl. H04L 12/24

(52) U.S. Cl. CPC H04L 41/08
USPC 370/255

(57) ABSTRACT

The present invention discloses a method, an apparatus, and a system for establishing a PVC link, and belongs to the field of access networks. The method includes: receiving, by a central office device, a detection cell sent by a terminal, where the detection cell carries a PVC parameter built in the terminal; judging whether service connection configurations of the central office device contain the PVC parameter; if true, looping back, by the central office device, the detection cell to the terminal, so that the terminal enables a PVC link corresponding to the PVC parameter and disables PVC links except the corresponding PVC link. The present invention further discloses a corresponding central office device and a terminal and a system comprised of the central office device and the terminal.

### CROSS-REFERENCE TO RELATED APPLICATIONS

This application is a continuation of International Application No. PCT/CN2011/080092, filed on Sep. 23, 2011, which claims priority to Chinese Patent Application No. 201110020083.7, filed on Jan. 18, 2011, both of which are hereby incorporated by reference in their entireties.

### TECHNICAL FIELD

The present invention relates to the field of access networks, and in particular, to a method, an apparatus, and a system for establishing a PVC link.

### BACKGROUND

In various layers of the communications field, the access network is a layer closest to users, and enables the users to access networks in the last several kilometers. An access device includes a central office device and a terminal. A PVC (Permanent Virtual Channel, permanent virtual channel) link needs to be established between the central office device and the terminal, that is, services can be interworked only when PVC parameters of the terminal and the central office device interconnected by a PVC are consistent.

At present, the central office device establishes a PVC link with the terminal by using a solution that the central office device adaptive PVC service configurations of the terminal. Multiple (generally eight) built-in PVC links are configured for a terminal at delivery from the factory, with each PVC link configured with different PVC parameters. The terminal enables all the built-in PVC links, and sends PVC parameters of each PVC link to the central office device one by one. After adapting to the first PVC link sent from the terminal, the central office device communicates with the terminal by using PVC parameters corresponding to the PVC link subsequently. After the terminal is restarted in the case of a power failure, the operation of establishing a PVC link is performed again.

During the implementation of the present invention, the inventor finds that the prior art has the following problems: The terminal enables multiple PVC links, and all PVC links perform transmission by taking up the uplink bandwidth no matter which PVC link is used by the peer central office device, thereby wasting the uplink bandwidth. In addition, the central office device adapts to the PVC service configurations of the terminal, which makes it inconvenient for the central office device to perform unified planning and management on PVC services. Furthermore, when the central office device does not adapt to the PVC service configurations, only manual configurations can be performed, thereby causing complex operations.

### SUMMARY

To save the uplink bandwidth in the process of establishing a PVC link, facilitate a central office device to perform unified planning and management on PVC services, and reduce manual interventions, embodiments of the present invention provide a method, an apparatus, and a system for establishing a PVC link. The technical solutions are as follows:

A method for establishing a PVC link includes:
receiving, by a central office device, a detection cell sent by a terminal, where the detection cell carries a permanent virtual channel PVC parameter built in the terminal;
judging, by the central office device, whether service connection configurations of the central office device contain the PVC parameter; and
if the judgment result is that the service connection configurations of the central office device contain the PVC parameter, looping back, by the central office device, the detection cell to the terminal, so that the terminal enables a PVC link corresponding to the PVC parameter and disables PVC links except the corresponding PVC link.

A method for establishing a PVC link includes:
selecting, by a terminal, a permanent virtual channel PVC parameter built in the terminal;
sending, by the terminal, a detection cell to a central office device, where the detection cell is an F5-level operation administration maintenance OAM cell and carries the selected PVC parameter built in the terminal, so that the central office device judges whether service connection configurations of the central office device contain the PVC parameter and loops back the detection cell to the terminal if the judgment result is that the service connection configurations of the central office device contain the PVC parameter; and
receiving, by the terminal, the detection cell looped back by the central office device, enabling a PVC link corresponding to the PVC parameter, and disabling PVC links except the corresponding PVC link.

A central office device includes:
a receiving module, configured to receive a detection cell sent by a terminal, where the detection cell carries a permanent virtual channel PVC parameter built in the terminal;
a judging module, configured to judge whether service connection configurations of the central office device contain the PVC parameter; and
a loopback module, configured to: if the judgment result is that the service connection configurations of the central office device contain the PVC parameter, loop back the detection cell to the terminal, so that the terminal enables a PVC link corresponding to the PVC parameter and disables PVC links except the corresponding PVC link.

A terminal includes:
a selecting module, configured to select a permanent virtual channel PVC parameter built in the terminal;
a sending module, configured to send a detection cell to a central office device, where the detection cell is an F5-level operation administration maintenance OAM cell and carries the selected PVC parameter built in the terminal, so that the central office device judges whether service connection configurations of the central office device contain the PVC parameter and loops back the detection cell to the terminal if the judgment result is that the service connection configurations of the central office device contain the PVC parameter; and
a processing module, configured to receive the detection cell looped back by the central office device, enable a PVC link corresponding to the PVC parameter, and disable PVC links except the corresponding PVC link.

A system for establishing a PVC link includes a terminal and a central office device.

The terminal is configured to select a permanent virtual channel PVC parameter built in the terminal, and send a detection cell to the central office device, where the detection cell is an F5-level operation administration maintenance OAM cell and carries the selected PVC parameter built in the terminal.

The central office device is configured to receive the detection cell sent by the terminal, judge whether service connection configurations of the central office device contain the PVC parameter, and loop back the detection cell to the terminal if the judgment result is that the service connection configurations of the central office device contain the PVC parameter.

The terminal is further configured to receive the detection cell looped back by the central office device, enable a PVC link corresponding to the PVC parameter, and disable PVC links except the corresponding PVC link.

The technical solutions provided in the embodiments of the present invention creates the following beneficial effects:

A terminal performs service detection on a central office device, and can identify, by using a detection cell looped back by the central office device, a PVC link used by the central office device; the terminal enables the PVC link and disables other PVC links, thereby saving the uplink bandwidth; the terminal adapts to PVC service configurations of the central office device, which facilitates the central office device to perform unified planning and management on PVC services. In addition, as a solution of adaptive PVC service configurations, when the central office device does not adapt to the PVC service configurations of the terminal, manual configurations are reduced.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and persons of ordinary skill in the art may still derive other drawings from these drawings without creative efforts.

FIG. 1 is a flowchart of a method for establishing a PVC link according to an embodiment of the present invention;

FIG. 2 is a flowchart of a method for establishing a PVC link according to another embodiment of the present invention;

FIG. 3 is a flowchart of a method for establishing a PVC link according to another embodiment of the present invention;

FIG. 4 is a schematic structural diagram of a central office device according to another embodiment of the present invention;

FIG. 5 is a schematic structural diagram of a terminal according to another embodiment of the present invention;

FIG. 6 is a schematic structural diagram of another terminal according to another embodiment of the present invention; and

FIG. 7 is a schematic structural diagram of a system for establishing a PVC link according to an embodiment of the present invention.

### DESCRIPTION OF EMBODIMENTS

To make the objectives, technical solutions, and advantages of the present invention more comprehensible, the following further describes the embodiments of the present invention in detail with reference to the accompanying drawings.

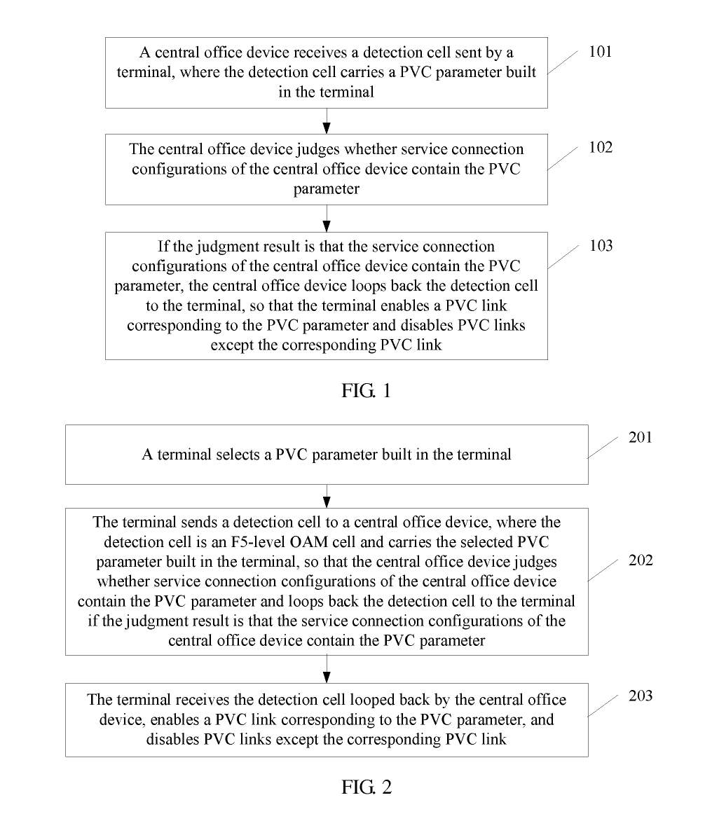

As shown in FIG. 1, an embodiment of the present invention provides a method for establishing a PVC link, including the following steps:

101. A central office device receives a detection cell sent by a terminal, where the detection cell carries a PVC parameter built in the terminal

The detection cell may be an F5-level OAM (operation administration maintenance, operation administration maintenance) cell.

102. The central office device judges whether service connection configurations of the central office device contain the PVC parameter.

103. If the judgment result is that the service connection configurations of the central office device contain the PVC parameter, the central office device loops back the detection cell to the terminal, so that the terminal enables a PVC link corresponding to the PVC parameter and disables PVC links except the corresponding PVC link.

Further, if the judgment result is that the service connection configurations of the central office device do not contain the PVC parameter, the central office device discards the detection cell.

In this embodiment, a central office device receives a detection cell that carries a PVC parameter sent by a terminal; when service connection configurations of the central office device contain the PVC parameter, the central office device loops back the detection cell to the terminal, so that the terminal identifies a PVC link used by the central office device, enables the PVC link, and disables other PVC links, thereby saving the uplink bandwidth; the terminal adapts to PVC service configurations of the central office device, which facilitates the central office device to perform unified planning and management on PVC services. In addition, as a solution of adaptive PVC service configurations, when the central office device does not adapt to the PVC service configurations of the terminal, manual configurations are reduced.

As shown in FIG. 2, another embodiment of the present invention provides a method for establishing a PVC link, including the following steps:

201. A terminal selects a PVC parameter built in the terminal.

202. The terminal sends a detection cell to a central office device, where the detection cell is an F5-level OAM cell and carries the selected PVC parameter built in the terminal, so that the central office device judges whether service connection configurations of the central office device contain the PVC parameter and loops back the detection cell to the terminal if the judgment result is that the service connection configurations of the central office device contain the PVC parameter.

203. The terminal receives the detection cell looped back by the central office device, enables a PVC link corresponding to the PVC parameter, and disables PVC links except the corresponding PVC link.

In this embodiment, a terminal performs service detection on a central office device, and can identify, by using a detection cell looped back by the central office device, a PVC link used by the central office device; the terminal enables the PVC link and disables other PVC links, thereby saving the uplink bandwidth; the terminal adapts to PVC service configurations of the central office device, which facilitates the central office device to perform unified planning and management on PVC services. In addition, as a solution of adaptive PVC service configurations, when the central office device does not adapt to the PVC service configurations of the terminal, manual configurations are reduced.

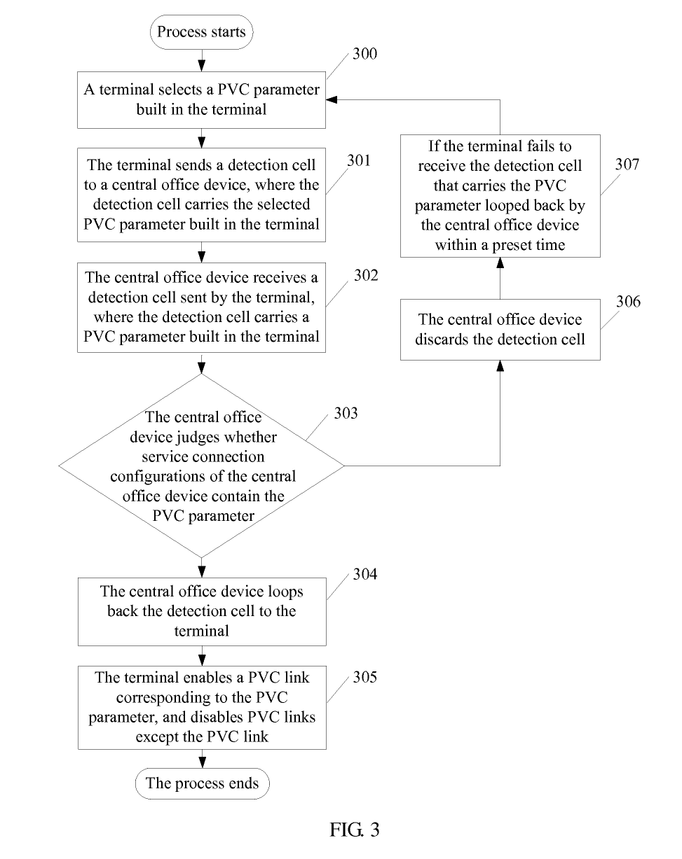

As shown in FIG. 3, another embodiment of the present invention provides a method for establishing a PVC link, including the following steps:

300. A terminal selects a PVC parameter built in the terminal.

301. The terminal sends a detection cell to a central office device, where the detection cell carries the selected PVC parameter built in the terminal.

The detection cell may be an F5-level OAM cell.

302. The central office device receives the detection cell sent by the terminal, where the detection cell carries a PVC parameter built in the terminal

303. The central office device judges whether service connection configurations of the central office device contain the PVC parameter.

Specifically, if the judgment result is that the service connection configurations of the central office device contain the PVC parameter, step 304 and step 305 are performed; if the judgment result is that the service connection configurations of the central office device do not contain the PVC parameter, step 306 and step 307 are performed.

304. The central office device loops back the detection cell to the terminal.

305. The terminal enables a PVC link corresponding to the PVC parameter, and disables PVC links except the PVC link. Then, the process ends.

306. The central office device discards the detection cell.

307. If the terminal fails to receive the detection cell that carries the PVC parameter looped back by the central office device within a preset time, step 300 is performed again until all PVC parameters built in the terminal are detected completely.

Further, if the terminal still fails to receive the detection cell looped back by the central office device after all the PVC parameters built in the terminal are detected completely, the terminal can establish a PVC link by using a manual configuration or a solution that the central office device adapts to PVC service configurations of the terminal in the prior art.

In this embodiment, a terminal performs service detection on a central office device, and can identify, by using a detection cell looped back by the central office device, a PVC link used by the central office device; the terminal enables the PVC link and disables other PVC links, thereby saving the uplink bandwidth; the terminal adapts to PVC service configurations of the central office device, which facilitates the central office device to perform unified planning and management on PVC services. In addition, as a solution of adaptive PVC service configurations, when the central office device does not adapt to the PVC service configurations of the terminal, manual configurations are reduced.

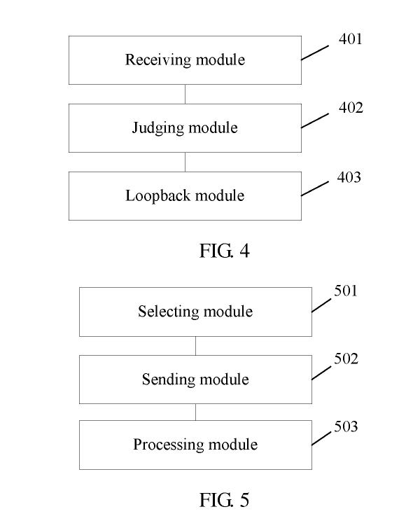

As shown in FIG. 4, another embodiment of the present invention provides a central office device, where the central office device includes:
a receiving module 401, configured to receive a detection cell sent by a terminal, where the detection cell carries a permanent virtual channel PVC parameter built in the terminal;
a judging module 402, configured to judge whether service connection configurations of the central office device contain the PVC parameter; and
a loopback module 403, configured to: if the judgment result is that the service connection configurations of the central office device contain the PVC parameter, loop back the detection cell to the terminal, so that the terminal enables a PVC link corresponding to the PVC parameter and disables PVC links except the corresponding PVC link.

Further, the central office device further includes:
a discarding module, configured to: if the judgment result is that the service connection configurations of the central office device do not contain the PVC parameter, discard the detection cell.

The detection cell is an F5-level operation administration maintenance OAM cell.

The central office device provided in this embodiment belongs to the same idea as the embodiments of the method. For details about the specific implementation processes of the central office device, reference may be made to the embodiments of the method, which are not further described herein.

In this embodiment, a central office device receives a detection cell that carries a PVC parameter sent by a terminal; when service connection configurations of the central office device contain the PVC parameter, the central office device loops back the detection cell to the terminal, so that the terminal identifies a PVC link used by the central office device, enables the PVC link, and disables other PVC links, thereby saving the uplink bandwidth; the terminal adapts to PVC service configurations of the central office device, which facilitates the central office device to perform unified planning and management on PVC services. In addition, as a solution of adaptive PVC service configurations, when the central office device does not adapt to the PVC service configurations of the terminal, manual configurations are reduced.

As shown in FIG. 5, another embodiment of the present invention provides a terminal, where the terminal includes:
a selecting module 501, configured to select a permanent virtual channel PVC parameter built in the terminal;
a sending module 502, configured to send a detection cell to a central office device, where the detection cell is an F5-level operation administration maintenance OAM cell and carries the selected PVC parameter built in the terminal, so that the central office device judges whether service connection configurations of the central office device contain the PVC parameter and loops back the detection cell to the terminal if the judgment result is that the service connection configurations of the central office device contain the PVC parameter; and
a processing module 503, configured to receive the detection cell looped back by the central office device, enable a PVC link corresponding to the PVC parameter, and disable PVC links except the corresponding PVC link.

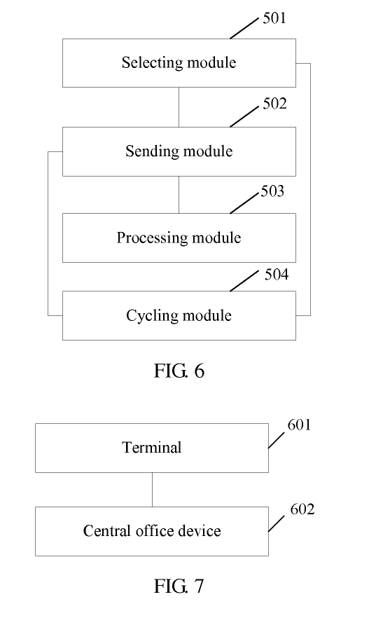

Further, as shown in FIG. 6, the terminal further includes:
a cycling module 504, configured to: after the function of the sending module 502 is performed, if the terminal fails to receive the detection cell that carries the PVC parameter looped back by the central office device within a preset time, perform the function of the selecting module 501 again until all PVC parameters built in the terminal are detected completely.

The terminal provided in this embodiment belongs to the same idea as the embodiments of the method. For details about the specific implementation processes of the terminal, reference may be made to the embodiments of the method, which are not further described herein.

In this embodiment, a terminal performs service detection on a central office device, and can identify, by using a detection cell looped back by the central office device, a PVC link used by the central office device; the terminal enables the PVC link and disables other PVC links, thereby saving the uplink bandwidth; the terminal adapts to PVC service configurations of the central office device, which facilitates the central office device to perform unified planning and management on PVC services. In addition, as a solution of adaptive PVC service configurations, when the central office device does not adapt to the PVC service configurations of the terminal, manual configurations are reduced.

As shown in FIG. 7, another embodiment of the present invention provides a system for establishing a PVC link, where the system includes a terminal 601 and a central office device 602.

The terminal 601 is configured to select a permanent virtual channel PVC parameter built in the terminal, and send a detection cell to the central office device 602, where the detection cell is an F5-level operation administration maintenance OAM cell and carries the selected PVC parameter built in the terminal.

The central office device 602 is configured to receive the detection cell sent by the terminal 601, judge whether service connection configurations of the central office device 602 contain the PVC parameter, and loop back the detection cell to the terminal 601 if the judgment result is that the service connection configurations of the central office device 602 contain the PVC parameter.

The terminal 601 is further configured to receive the detection cell looped back by the central office device 602, enable a PVC link corresponding to the PVC parameter, and disable PVC links except the corresponding PVC link.

Further, the central office device 602 is configured to discard the detection cell if the judgment result is that the service connection configurations of the central office device 602 do not contain the PVC parameter.

Further, the terminal 601 is further configured to: if the terminal fails to receive a detection cell that carries the PVC parameter looped back by the central office device 602 within a preset time, perform the step of selecting a PVC parameter built in the terminal again until all PVC parameters built in the terminal are detected completely.

The terminal and the central office device involved in the system provided in this embodiment belong to the same idea as the embodiments of the method. For details about the specific implementation processes of the terminal and the central office device, reference may be made to the embodiments of the method, which are not further described herein.

In this embodiment, a terminal performs service detection on a central office device, and can identify, by using a detection cell looped back by the central office device, a PVC link used by the central office device; the terminal enables the PVC link and disables other PVC links, thereby saving the uplink bandwidth; the terminal adapts to PVC service configurations of the central office device, which facilitates the central office device to perform unified planning and management on PVC services. In addition, as a solution of adaptive PVC service configurations, when the central office device does not adapt to the PVC service configurations of the terminal, manual configurations are reduced.

All or some contents of the technical solutions provided by the foregoing embodiments may be implemented by software programming, and software programs thereof are stored in a readable storage medium such as a hard disk, a compact disk, or a floppy disk of a computer.

The foregoing descriptions are merely exemplary embodiments of the present invention, but are not intended to limit the present invention. Any modification, equivalent replacement, or improvement derived within the spirit and principle of the present invention shall fall within the protection scope of the present invention.

What is claimed is:

1. A method for establishing a permanent virtual channel (PVC) link, comprising:
receiving, by a central office device, a detection cell sent by a terminal, wherein the detection cell carries a PVC parameter built in the terminal;
judging, by the central office device, whether service connection configurations of the central office device contain the PVC parameter; and
if the judgment result is that the service connection configurations of the central office device contain the PVC parameter, looping back, by the central office device, the detection cell to the terminal, so that the terminal enables a PVC link corresponding to the PVC parameter and disables PVC links except the corresponding PVC link.

2. The method according to claim 1, wherein after the judging, by the central office device, whether service connection configurations of the central office device contain the PVC parameter, the method comprises:
if the judgment result is that the service connection configurations of the central office device do not contain the PVC parameter, discarding, by the central office device, the detection cell.

3. The method according to claim 1, wherein the detection cell is an F5-level operation administration maintenance (OAM) cell.

4. A method for establishing a permanent virtual channel (PVC) link, comprising:
selecting, by a terminal, a PVC parameter built in the terminal;
sending, by the terminal, a detection cell to a central office device, wherein the detection cell is an F5-level operation administration maintenance (OAM) cell and carries the selected PVC parameter built in the terminal, so that the central office device judges whether service connection configurations of the central office device contain the PVC parameter and loops back the detection cell to the terminal if the judgment result is that the service connection configurations of the central office device contain the PVC parameter; and
receiving, by the terminal, the detection cell looped back by the central office device, enabling a PVC link corresponding to the PVC parameter, and disabling PVC links except the corresponding PVC link.

5. The method according to claim 4, wherein after the sending, by the terminal, a detection cell to a central office device, the method further comprises:
if failing to receive a detection cell that carries the PVC parameter looped back by the central office device within a preset time, performing, by the terminal, the step of selecting a PVC parameter built in the terminal again until all PVC parameters built in the terminal are detected completely.

6. A central office device, comprising:
a receiving module, configured to receive a detection cell sent by a terminal, wherein the detection cell carries a permanent virtual channel (PVC) parameter built in the terminal;
a judging module, configured to judge whether service connection configurations of the central office device contain the PVC parameter; and
a loopback module, configured to: when the judgment result is that the service connection configurations of the central office device contain the PVC parameter, loop back the detection cell to the terminal, so that the terminal enables a PVC link corresponding to the PVC parameter and disables PVC links except the corresponding PVC link.

7. The central office device according to claim 6, further comprising:
a discarding module, configured to: when the judgment result is that the service connection configurations of the central office device do not contain the PVC parameter, discard the detection cell.

8. A terminal, comprising:
a selecting module, configured to select a permanent virtual channel (PVC) parameter built in the terminal;
a sending module, configured to send a detection cell to a central office device, wherein the detection cell is an F5-level operation administration maintenance (OAM) cell and carries the selected PVC parameter built in the terminal, so that the central office device judges whether service connection configurations of the central office device contain the PVC parameter and loops back the detection cell to the terminal if the judgment result is that the service connection configurations of the central office device contain the PVC parameter; and
a processing module, configured to receive the detection cell looped back by the central office device, enable a PVC link corresponding to the PVC parameter, and disable PVC links except the corresponding PVC link.

9. The terminal according to claim 8, further comprising:
a cycling module, configured to: after the function of the sending module is performed, if the terminal fails to receive the detection cell that carries the PVC parameter looped back by the central office device within a preset time, perform the function of the selecting module again until all PVC parameters built in the terminal are detected completely.

10. A system for establishing a permanent virtual channel (PVC) link, comprising a terminal and a central office device, wherein:
the terminal is configured to select a PVC parameter built in the terminal, and send a detection cell to the central office device, wherein the detection cell is an F5-level operation administration maintenance (OAM) cell and carries the selected PVC parameter built in the terminal;
the central office device is configured to receive the detection cell sent by the terminal, judge whether service connection configurations of the central office device contain the PVC parameter, and loop back the detection cell to the terminal if the judgment result is that the service connection configurations of the central office device contain the PVC parameter; and
the terminal is further configured to receive the detection cell looped back by the central office device, enable a PVC link corresponding to the PVC parameter, and disable PVC links except the corresponding PVC link.
